(19) United States
(12) Patent Application Publication
(10) Pub. No.: US 2025/0241487 A1
(43) Pub. Date: Jul. 31, 2025

(54) SYSTEM TO REMOVE FOOD PARTICLES FROM A VAT FOR CONTINUOUSLY COOKING FOOD

(71) Applicant: MP EQUIPMENT, LLC, Gainesville, GA (US)

(72) Inventors: Mike MITCHELL, Gainesville, GA (US); Allen ZANDI, Gainesville, GA (US); Julian WILKS, Gainesville, GA (US)

(21) Appl. No.: 19/038,202

(22) Filed: Jan. 27, 2025

Related U.S. Application Data
(60) Provisional application No. 63/626,014, filed on Jan. 28, 2024.

(51) Int. Cl. A47J 37/12

(52) U.S. Cl. CPC A47J 37/1285; A47J 37/1214; A47J 37/1223

(57) ABSTRACT

An oil receiving system includes a housing proximate to a vat and a fluid connection disposed in either the side wall or the bottom wall, the fluid connection vertically disposed below a top edge of the front wall and a system to remove the contents within the housing through the fluid connection. The housing is connected to a cooking vat by a transition between the outer edge of the vat and the front wall of the housing, the transition extends at an upwardly extending orientation from the outer edge of the vat to the front wall of the housing, wherein a conveyor extends along the transition, the conveyor has a first portion that moves along the transition from over the outer edge of the vat and toward and over the front wall of the housing, and a second portion that moves along the transition from over the front wall of the housing and toward and over the outer edge of the vat.

### CROSS-REFERENCE TO RELATED APPLICATIONS

This application claims priority from U.S. Provisional Application No. 63/626,014, filed Jan. 28, 2024, the entirety of which is hereby incorporated by reference herein.

### BACKGROUND OF THE INVENTION

This application relates to commercial system to cook food items in liquid, where the liquid is directly exposed to the food being cooked, such as deep fat fryers. Over time with continuously cooking food items within the liquid, crumbs or particles of food being cooked often fall off the food and into the liquid. The subject specification relates to systems to remove the crumbs or particles of food that fall into the liquid over time.

### SUMMARY OF THE INVENTION

A first representative embodiment of the disclosure is provided.

The embodiment includes a system to remove foreign matter from cooking oil. The system includes a vat that receives a volume of heated oil for cooking food products therein, the oil establishes a nominal top oil surface during heated cooking operations within the vat, the vat supporting a first conveyor system that causes movement of a food product from an inlet end to an exit end of the vat, the vat is configured to receive the volume of heated oil such that the nominal top oil surface is above at least a portion of the first conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the first conveyor system, and the exit portion is proximate to a different position where the food product exits the vat after reaching an opposite end of the first conveyor system, the vat comprises a bottom surface at a bottom portion thereof, with the sidewall extending vertically from the bottom portion. A receipt plenum is positioned proximate to the exit end of the vat, the receipt plenum includes a housing that includes a front wall, a bottom surface, at least one side surface, further comprising a fluid connection to an external system to filter or otherwise process oil, wherein the fluid connection is disposed within the receipt plenum. A second conveyor system extends between the vat and the receipt plenum, the second conveyor system extends from proximate to the inlet end over the exit end of the vat and into a position aligned above the housing of the receipt plenum, the second conveyor system includes a first portion that moves from a position proximate to the inlet end toward the position aligned above the housing, and a second portion that moves from the position aligned above the housing toward the position proximate to the inlet end, wherein one of the first or second portions of the conveyor moves across and in contact with the bottom portion of the vat.

Another representative embodiment of the disclosure is provided and includes an oil receiving system. The system includes a housing that includes a front wall, a side wall, and a bottom wall, the front wall being configured positioned proximate to an outer edge of a vat and positioned with a space between the outer edge of the vat and the front wall of the housing, the combined front wall, side wall, and bottom wall form a plenum for receipt of oil therein. A fluid connection is disposed in either the side wall or the bottom wall, the fluid connection vertically disposed below a top edge of the front wall. A piped system that allows flow from within the plenum through the fluid connection, and a valve disposed at or proximate to the fluid connection and operable to either allow flow from the plenum through the fluid connection or prevent flow from the plenum through the fluid connection. A transition is provided between the outer edge of the vat and the front wall of the housing, the transition extends at an upwardly extending orientation from the outer edge of the vat to the front wall of the housing, wherein a conveyor extends along the transition, the conveyor has a first portion that moves along the transition from over the outer edge of the vat and toward and over the front wall of the housing, and a second portion that moves along the transition from over the front wall of the housing and toward and over the outer edge of the vat.

Further representative embodiments include the Numbered Paragraphs provided at the end of the specification and various combinations of those Numbered Paragraphs as discussed therein.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of a cooking system that includes a crumb removal system

FIG. 2 is a right side cross-sectional view of the cooking system of FIG. 1 of section E-E.

FIG. 3 is cross-sectional view of FIG. 2 with the first conveyor system removed.

FIG. 4 is a perspective view of a receipt plenum of the cooking system of FIG. 1 and an outlet end portion of the cooking system.

FIG. 5 is another perspective view of the receipt plenum of the cooking system of FIG. 1 with the first conveyor system removed.

FIG. 5a is a perspective cross-sectional view of the view of FIG. 5 of section F-F.

FIG. 6 is a different perspective cross-sectional view of the receipt plenum and the outlet portion of the cooking system about section F-F.

FIG. 6a is a right side cross-sectional view of the section F-F.

FIG. 7 is a detail view of the heating system of the vat of FIG. 1.

### DETAILED DESCRIPTION OF THE INVENTION

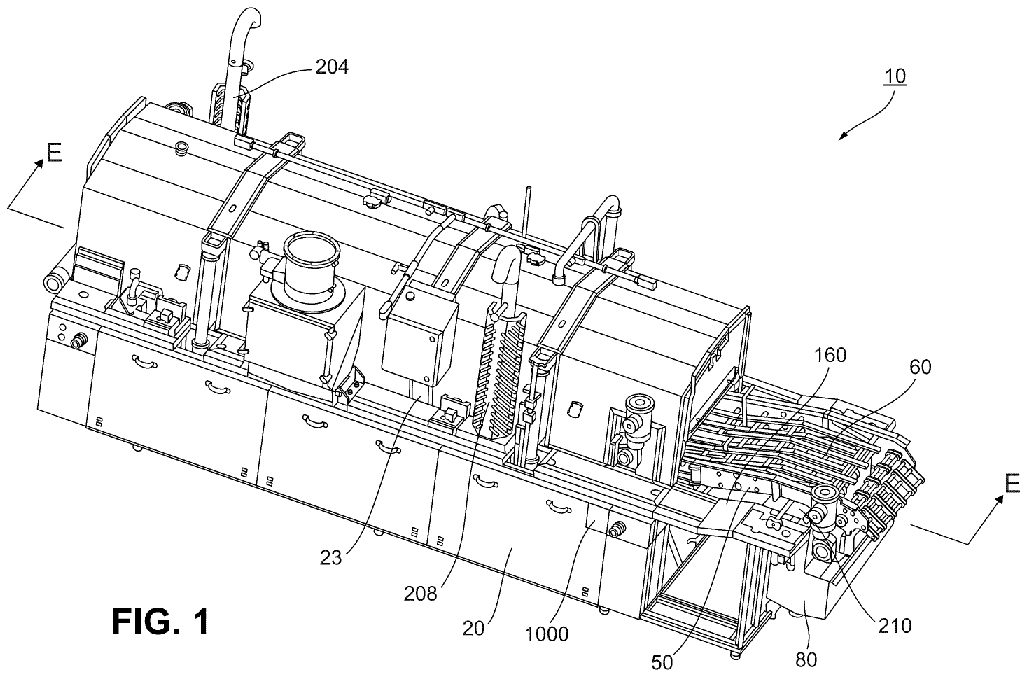

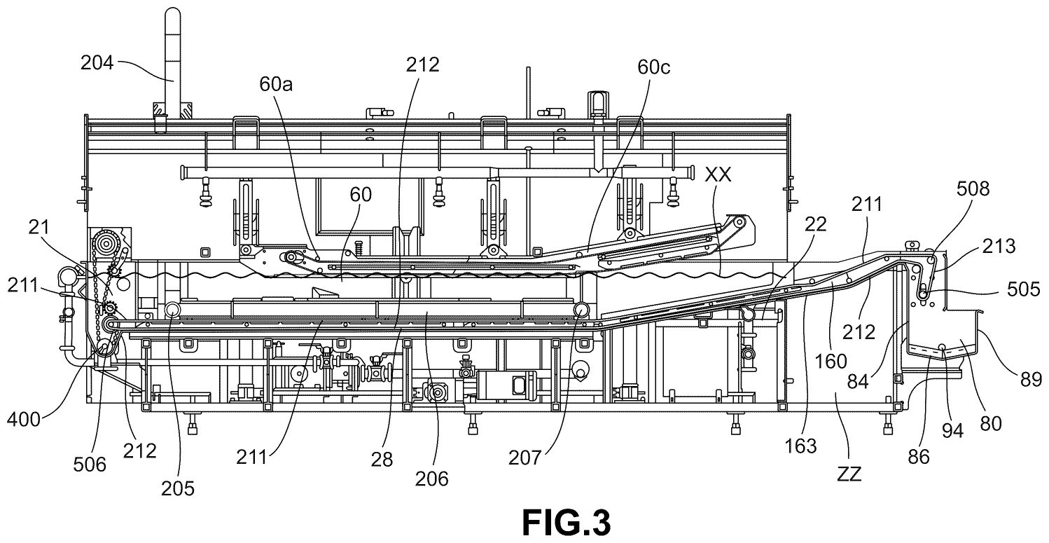

Turning now to FIGS. 1-7, a system 10 to remove foreign matter from cooking oil within a cooking system is provided. The cooking system is depicted herein as a deep fat fryer that is configured for frying foods that are moved through the vat 20 via a conveyor belt 60, but other types of cooking systems that cook with hot oil, or water, or other liquids may be provided with the system 10 in other embodiments. For the sake of brevity, this specification will describe in detail the system for use with frying foods with hot cooking oil. One of ordinary skill in the art with a thorough review and understanding of this specification will readily comprehend how the system 10 may be used, and the modifications needed for use, with other cooking liquids and with vats that do not use a conveyor to move food to be cooked through the vat with merely routine optimization. Any substantive structural or functional differences for use with the system with other types of cooking fluids or other motive features will be specifically discussed herein.

The food that can be cooked within the system 10 may be anything that is desired to be cooked by complete or partial frying in hot oil, and specifically by facilities that cook a large amount of food by frying. The food may be chicken fingers or chicken nuggets, other protein than chicken, or potatoes, vegetables, cheese, and the like. The system 10 is configured in a similar manner for cooking different foods by frying and to vary the amount of cooking (fully cooking, half cooking, etc.) and the amount of frying and the type of foods to be fried do not have any significant impact upon the design of the system 10 other than an impact of the design and operation of the vat, the operation of the conveyors, the temperature of the heating oil, and the flow of the heated oil within the vat—all of which are of which can be optimized by one of ordinary skill in the art with a thorough review of the this specification and a good understanding of the cooking that is desired of the food item within the vat 20.

The system 10 may be used with a vat 20, such as a vat that includes heated cooking oil for frying foods disposed in the heated oil. The cooking oil W may be heated with gas burners or electrical heating elements as is well known in the art. The oil W may be heated within the vat 20, while in other embodiments, the oil may receive heat from a heat exchange system that is located outside of the vat and the oil flows out of the vat 20 to receive the heat and then returns to the vat to provide the heat input into the vat 20.

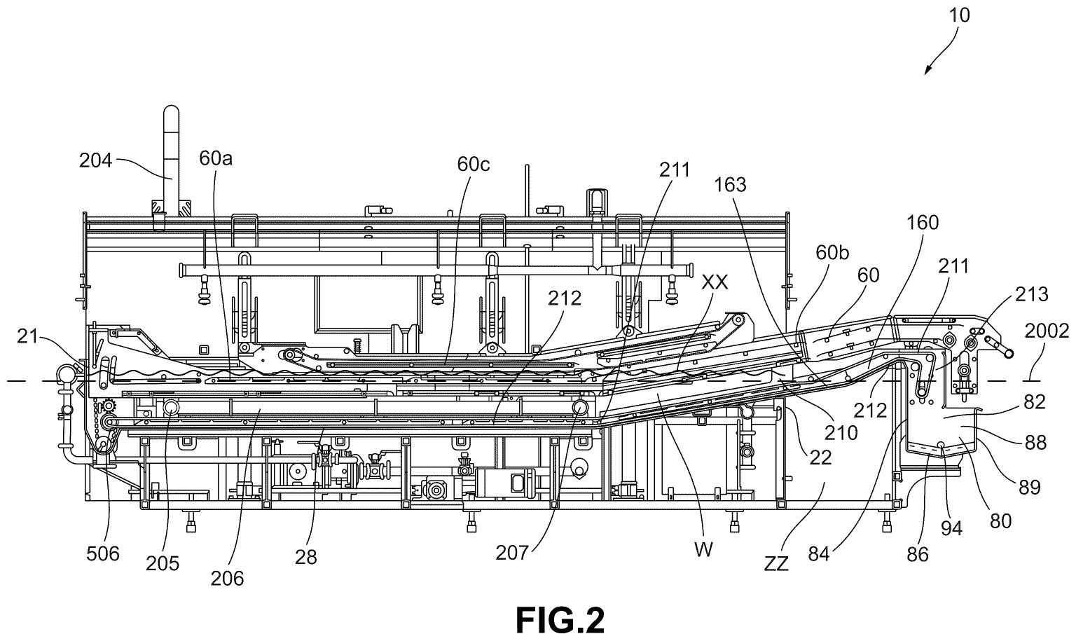

The vat 20 may include one or more conveyor systems 60 that urge foods that are received within the vat 20 to move to another portion of the vat during the cooking process. The conveyor systems 60 may be timed to move the food items received thereon at a speed that causes the food items that are received within the vat to transition to an exit portion of the vat 20 at the same time that the food is fully cooked (or fully processed) within the vat according to the desired functionality of the vat 20. In some embodiments, the first conveyor system 60 may include a single conveyor, while in other embodiments, the first conveyor system 60 may include multiple conveyors, such as two conveyors. In this embodiment, a first conveyor 60a within the first conveyor system 60 may receive the food item when it is first deposited into the vat and transition the food item along portion of the vat 20 and through the oil within the vat associated with the desired cooking step, and upon reaching an end of the first conveyor 60a the food item may be deposited upon a second conveyor 60b to move the food item out of the vat and toward a next step in the cooking process. In some embodiments including the embodiment depicted in the figures an upper conveyor 60c may be provided. The upper conveyor 60c is positioned above a significant portion or the entirety of the first conveyor 60a and particularly the portion of the first conveyor 60a that extends below the nominal top surface XX of the cooking oil (FIG. 2, schematic), with the upper conveyor 60c provided to cause the food that moves between the first and second conveyors 60a, 60b to transition below the nominal top surface of the cooking oil. The term nominal top surface is defined herein to be a plane 2002 (shown as a line on the side-view perspective of FIG. 2) that extends through the top surface of the oil within the vat if the amount of oil in the vat 20 were completely still. The upper conveyor 60c is provided to maintain the food item between the first and third conveyors 60a, 60c and specifically to maintain the food items therebetween within the and surrounded by oil within the vat 20. The conveyors within the first conveyor system 60 may be any type of conveyor known in the art to support a food item thereon (or thereunder in the case of an upper third conveyor 60c) and to allow the cooking oil to flow therethrough in order for heated oil to contact the outer surfaces of the food as the food is moved along the first conveyor through the vat. Accordingly, the conveyors of the first conveyor system 60, and specifically the first and upper conveyors 60a, 60c that support the food as it is cooked within the oil may be include wires or other thin structures that provide mechanical support to the food item, but minimize the contact with the food to maximize the contact of the food with the cooking oil.

In some embodiments, the conveyor(s) 60 may include a continuous flat belt type conveyor (with a plurality of holes through the flat belt to allow the oil to flow therethrough). The conveyor(s) may also be flat (such that food items rest thereon) but discontinuous such that there are periodically portions that support food thereon and between them portions that do not support food thereon. Still alternatively, the conveyor may include a plurality of spaced apart baskets that support foods therein.

The vat 20 includes outer side walls that retain the oil therewith and provide structural support for the conveyors, the oil heating equipment, and other equipment that is associated with cooking within the vat 20. The outer side walls include first and second end walls 21, 22, which are proximate to the positions where the food is introduced into the vat (the entry portion) and the position where the food is removed from the vat (the exit portion, often at an opposite end portion of the vat from the entry portion), respectively. The vat 20 additionally includes side walls 23, 24 that extend between the first and second end walls.

Each of the end walls and the two side walls 21, 22, 23, 24 include a top edge that is located at a height that is above the nominal top surface XX of the oil within the vat to prevent the oil from leaving the vat 20 by spilling over the sides. The top edge of the end walls and the two side walls of the vat is additionally above the highest expected oil level within the vat during operations and at a height that would prevent oil splashes created during normal operation of the system to escape the vat. One of ordinary skill in the art with a thorough review of this specification and routine experimentation of the oil's typical transients during normal operation of the system 10 can readily establish a height of the walls of the vat to prevent significant oil from leaving the vat over the side walls during normal operation (not including the oil flowing into the overflow plenum 100 as discussed herein).

The system 10 includes a receipt plenum 80 that is disposed proximate to the vat 20. In some embodiments, the receipt plenum 80 is disposed proximate to the second (rear or outlet end from the perspective of the travel of food to be cooked through the vat 20) end wall 22, while in other embodiments, the receipt plenum 80 may be disposed proximate to the first (inlet) end wall 21. The term proximate is defined herein to cover embodiments where the receipt plenum includes one or more surfaces that are in contact with one or more surfaces of the vat 20 (such as an end wall 21, 22) or positioned such that there is a space (ZZ, FIG. 2) disposed between a surface of the vat and a closest surface of the receipt plenum 80. In some embodiments, the space may be a small distance (less than a foot) while in other embodiments the space may be several feet therebetween.

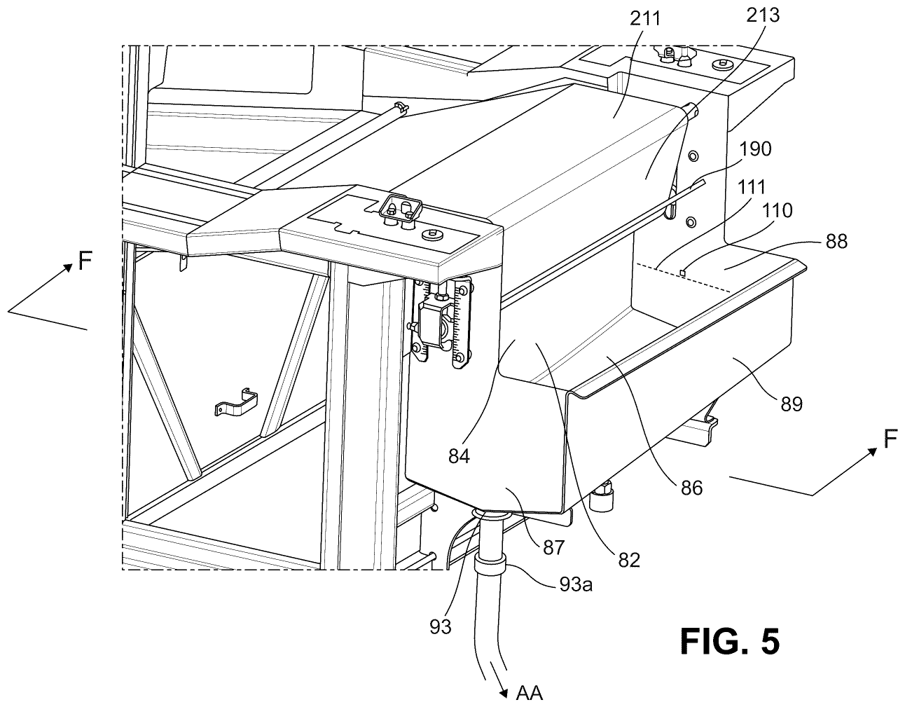

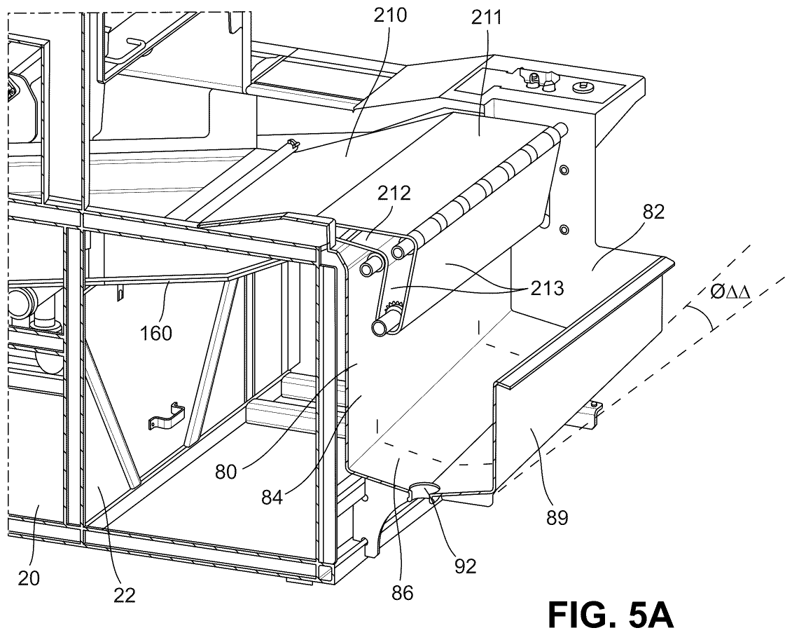

The receipt plenum 80 includes a housing 82 that is configured to receive particulate matter therein as well as oil therein. The housing 82 includes a front wall 84, a bottom surface 86, right and left surfaces 87, 88, and a rear surface 89. The housing 82 includes a fluid connection 92 that allows particulate matter and oil to flow therethrough for disposal or for filtering and return to the vat 20. The fluid connection 92 may be fluidly connected to an external filtration system (downstream of flow path SS in FIG. 5) (not shown, but conventional). A valve 93a (schematic) may be disposed to be repositioned between a closed position where the fluid connection 92 is blocked to prevent fluid and particulate matter from within the housing to flow therethrough, to an open position to allow flow through the fluid connection 92 and out of the receipt plenum 80 as discussed herein. The position of the valve 93a may be controlled by a controller 1000 (schematic). The controller 1000 control the valve 93a (i.e. causing the valve to be opened and remain open for a certain period of time) based upon one or a number of potential control strategies. A first strategy may be based upon opening the valve at specific time intervals during operation of the vat 20 and specifically during operation of the second conveyor system 210 as discussed herein, such that the valve periodically is opened to allow oil and particulate within the receipt plenum 80 to flow out through the fluid connection 92. The time intervals may be selected to be less than a typical time when liquid and particulate matter fills to a certain level within the receipt plenum during operation of the system, such as 50 percent of the allowed level within the housing 82 of the receipt plenum 80.

In an alternative control strategy, a level sensor 110 may monitor the level of liquid/particulate matter within the housing 82, and the level sensor 110 may provide a signal where the controller causes the valve 93a to open when level is sensed (such as at the level line 111 associated with the sensor 110) or a certain delay time after the sensor 110 identifies the level is at the level line 111. In still other embodiments, the weight of the receipt plenum 80 may be monitored, with the weight changing as additional liquid/particulate matter is deposited within the housing 82 of the receipt plenum 80. The controller 1000 may cause the valve 93a to open when the weight has increased to a predetermined level that is associated with a level of liquid and particulate matter that should be removed from the receipt plenum 80. In some embodiments, the controller 1000 may receive some or all of these indications (including elapsed time during operation) and cause the valve 93a to operate as needed due to the receipt of a signal (or a determination of a condition of the contents within the receipt plenum 80) as discussed above.

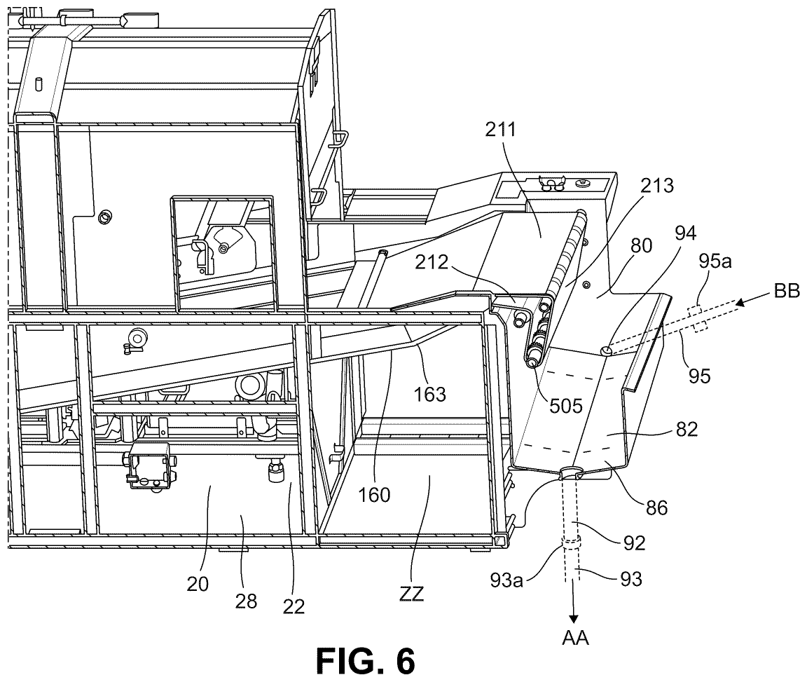

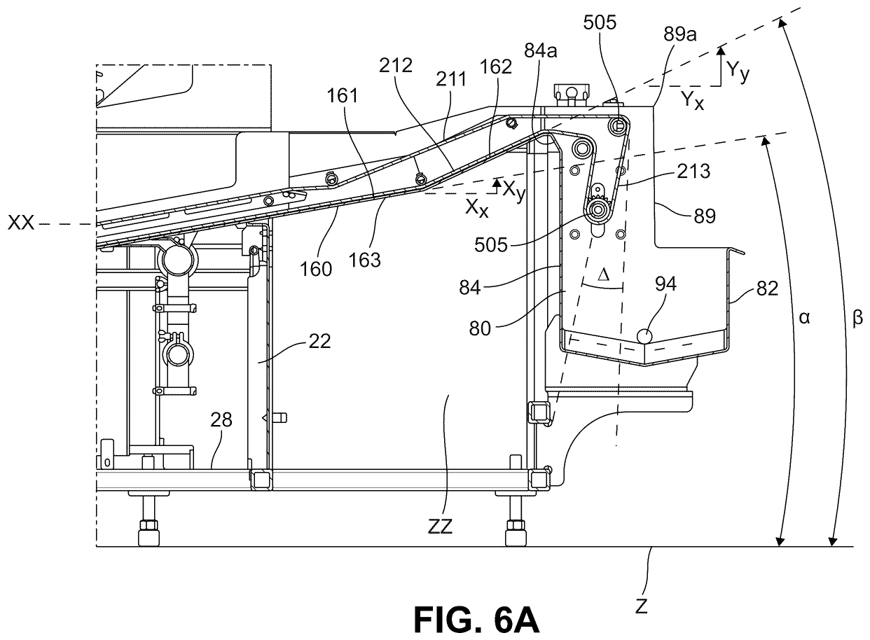

In some embodiments, the housing 82 may include a second aperture 94 that is provided that is preferably located at a different portion of the housing 82 than the fluid connection 92. The second aperture 94 may be located upon the bottom surface 86 or on a side wall—such as the left wall 88, such as when the fluid connection is proximate to the right wall 87. The second aperture 94 may be fluidly connected to a source of flowing oil BB (FIG. 6, schematic) such that when a valve 95a (schematic) that is fluidly connected to the second aperture 94 is opened oil flows through the second aperture 94 and into the housing 82 and when the valve 95a is closed no oil flows into the housing 82. In some embodiments, the second aperture 94 may be fluidly connected to the vat 20 such that oil from the vat flows through the valve 95a and flow path 95 (BB) (when opened) and into the housing 92. Alternatively, the second aperture 94 may be fluidly connected to an oil tank (not shown, by way of piping 95) that is configured to provide replacement oil to the vat 20 as is periodically necessary (due to the accumulated oil loss from the vat 20 due to oil soaking into the food product during the frying process, the accumulated oil that is transferred into the housing 82 as discussed herein, oil that is removed for filtering, and the like). The controller 1000 may control the valve 95a to selectively open the valve 95a to allow oil to flow into the housing (BB). The controller 1000 may be configured to open the valve 95a to allow oil to flow into the housing 82 at the same time as or just before the opening of the valve 93a associated with the fluid connection 92. The flowing of oil through the second aperture 94 (BB) assists in some circumstances with removing particulate matter from the housing 82, particularly in circumstances when the particulate matter that has built up in the housing 80 has a low oil content. The introduction of oil through the second aperture 94 interacts with the particulate matter and allows it to drain through the fluid connection 92.

In some embodiments, the bottom surface 86 of the housing 80 may be disposed at an angle (such as an acute angle AA with respect to a floor surface that the system rests upon) to define a low point or low region 86a (such as with the right side lower than the left side, the left side lower than the right side, or with a low point in the center or offset from a center of the bottom surface 86). The fluid connection 92 may be positioned at or proximate to the low point (low region) to allow all (defined to include substantially all liquid other than liquid that remains upon the walls after draining due to surface tension or frictional forces) liquid to flow through the fluid connection 92 and out of the housing due to gravity, with the flow in some embodiments as discussed herein enhanced by the introduction of oil flowing through the second aperture 94.

The receipt plenum 80 is mechanically connected to the vat 20 with a transition 160. The transition extends from the end of the vat 20 (21, 22) proximate to the receipt plenum 80 to the receipt plenum 80. In some embodiments, the transition 160 extends from the second (outlet) end 22 of the vat 20 and to the receipt plenum 80, which is disposed proximate to the vat 20. In another embodiment where the receipt plenum is disposed proximate to the first (inlet) end 21 of the vat, the transition 160 extends from the inlet end 21 to the receipt plenum 80.

The transition 160 extends from the vat 20 to the receipt plenum 80 with an orientation that has an upward vector component Xy and a horizontal vector component Xx that extends away from the vat 20 and toward the receipt plenum, such that the transition extends at an acute angle α with respect to the horizontal surface Z that the vat 20 rests upon. In some embodiments, the transition 160 extends at different orientations along its length, with a first portion 161 that extends at vector X (at angle α) and a second portion with a larger angle β, with an upward vector component Yy and a horizontal vector component Yx.

The transition 160 has a flat bottom surface 163 along its length, the bottom surface forms a straight line between the left and right sides of the transition along the length of the transition (with the orientation or positions of the straight lines changing along the length of the transition 160).

The transition 160 extends to a height that is above the nominal oil level within the vat (XX) and continues to extend with an increasing vertical vector (i.e. Xy or Yy—FIG. 6a) as the transition extends outside of the vat 20 and toward a position where the transition is aligned with the receipt plenum 80. The increasing vertical position of the transition 160 prevents oil from flowing out of the vat 20 along the transition 160 because oil that reaches the transition tends to drain back toward the vat 20 due to the force of gravity (and the slope of the transition toward the vat 20), and due to the movement of the second portion 220 of the second conveyor 210 as discussed herein.

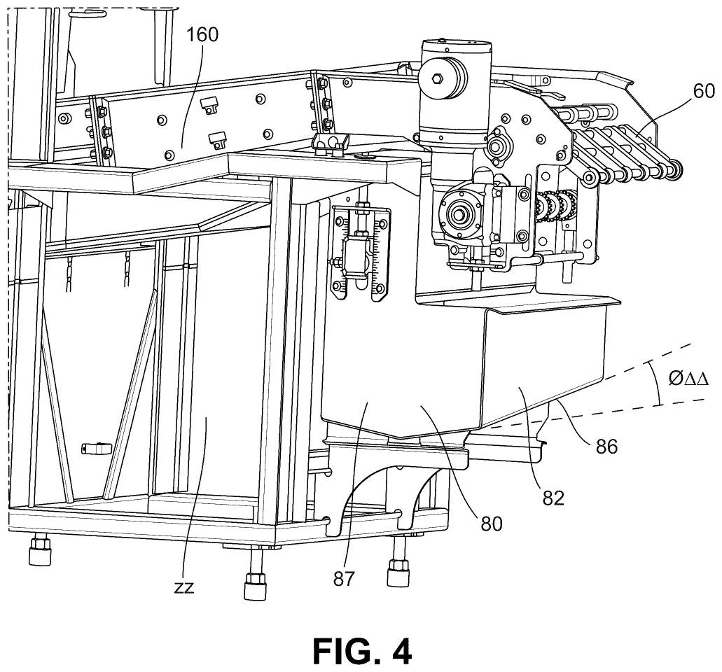

The system 10 includes a second conveyor system 210 that is disposed below the first conveyor system 60. The first conveyor system 60, as discussed above, is provided to receive food thereon at or proximate to the inlet end 21 of the vat 20 and move the food through the vat 20 and in some embodiments below the nominal surface XX of the cooking oil such that the food is cooked/fried as it travels through the vat 20 toward the outlet end 22. As shown in FIG. 2, at or before the outlet end 22 the first conveyor system 60 raises the food above the nominal level XX of the oil and moves the food away from the vat 20 and to another station—i.e. for further cooking, baking, drying, freezing, packaging or other desired steps for the food. The first conveyor system 60 extends over the second conveyor system 200 and above the receipt plenum 80 as depicted in FIG. 4. The first conveyor system 60 is aligned above the second conveyor system along the transition 160 and above the receipt plenum 80 such that oil or crumbs that drip/fall from the food after it leaves the vat 20 falls onto the transition 160 or the receipt plenum 80 to avoid loss of oil from the system 10 and to minimize the mess of dripping oil/crumbs as much as possible.

The second conveyor system 210 is provided to urge crumbs from within the vat 20 toward the receipt plenum 80 and to urge crumbs and particulate matter that is proximate to the bottom surface 28 of the vat 20 to the front portion of the vat 21 where it is received by a grinder 400 and a filtration system 402 (schematic) that is provided proximate to the front end portion 21 of the vat 20.

The second conveyor system 210 includes a first portion 211 that extends from a position proximate to the inlet (front) end portion 21 of the vat 20 across and above the transition until reaching a position that is above the housing 82 of the receipt plenum. The second conveyor 210 further includes a second portion 211 that extends from a position above the housing 82 of the receipt plenum 80 and travels above or along the flat bottom surface 163 of the transition 160 and into the vat 20 and traveling along or proximate to the bottom surface 28 of the vat 20 until returning to a position proximate to the inlet end 21. In some embodiments, the second conveyor system 210 additionally includes a third portion 213 that is between the end of the first portion 211 and the start of the second portion 212. The third portion 213 extends substantially vertically downward in a position that is above and aligned over the housing 82 (storage volume) of the receipt plenum 80. The term substantially vertically downwardly includes directly downward (i.e. in the same direction as the force of gravity) or at an angle A that is within 15 degrees of the downward direction. The third portion 213 extends substantially vertically downward for a distance such that a bottom most portion (at a gear 505 or sprocket that redirects the third portion substantially upward) is located a position that is below a top edge 84a of the front wall 84 of the receipt plenum and in some embodiments below a top edge 89a of the rear wall 89 of the receipt plenum. The third portion 213 then transitions in an upward direction (either directly upward or at an angle with respect to the vertical as depicted in FIG. 6a) to the second portion 212 to return across the transition 160 and return to the vat 20. As depicted in the figures, the second conveyor system 210 is urged by an input drive 506, which may be positioned proximate to the inlet end 21 of the vat, or may be a different position of the second conveyor 210 where the conveyor wraps around the input for a substantial circumferential percentage of the input (such as about 180 degrees). The second conveyor system 210 is directed in different directions and orientations along its length by various idler gears 505.

The second conveyor system 210 is positioned below the first conveyor system 60 such that oil or crumbs that fall through the first conveyor system 60 falls toward the second conveyor system 210.

The first portion 211 extends through the cooking oil, in some embodiments below the manifolds 205, 207 and heating tubes 206 of the heating system 200 as discussed below. As the first portion approaches the outlet portion 22 of the vat, the first portion 211 extends at an upward angle until reaching the transition 160 and then extends above the transition 160 at an orientation that is parallel or about parallel with angle of the transition 160 as discussed above. As the first portion 211 runs through the top surface XX of the oil crumbs or particulate matter that is floating on the top surface XX of the oil contacts the moving first portion 211 and rides upon the conveyor and out of the oil. The continuous movement of the first portion 211 tends to continuously remove crumbs that are floating upon the oil. Crumbs that coalesce into a certain size or mass tend to sink within the oil and drop through the oil until they reach the location of the first portion 211 proximate to the bottom surface 28 of the vat 20, and the continuous movement of the first portion 211 moves these crumbs through the vat and out of the vat as the first portion 211 moves out of the vat and into registry with the transition 160. The crumbs that rest upon the first portion 211 move with the first portion 211 and when the conveyor changes direction to the substantially vertically downward direction, which causes the crumbs to fall downwardly and off of the conveyor 210 due to the force of gravity. In some embodiments, a scraper (190) may be positioned along the third portion 213 of the second conveyor and contact or be in very close position to the conveyor to scrape particulate matter that rests upon the conveyor off of the conveyor and to fall into the receipt plenum.

The second portion 212 is vertically below the first portion. The second portion 212 may contact the bottom surface 163 of the transition 160 as the second portion moves along the transition 160 and toward the vat. The movement of the second portion 212 across the bottom surface 163 of the transition 160 contacts any crumbs or particulate that is along the bottom surface and drags those into the vat along with movement of the second portion. The second portion 212 once reaching the vat may contact the bottom surface 28 of the vat as it moves toward the first end 21 and cause movement of any crumbs that reach the bottom surface 28 toward the first end. As mentioned above, in some embodiments, a grinder 400 is positioned at the front end 21 and positioned to receive the crumbs that are pushed across the bottom of the vat by the second portion 212. The second portion 212 then transitions again to the first portion 211 via a gear/sprocket 505, which in some embodiments is the input.

The vat 20 receives a heating system 100 that is configured to transfer heat to the oil therein. The heating system 200 is a heat exchanger 202 that is disposed within the vat 20 and within a position where the oil within the vat surrounds the heat exchanger. The heat exchanger 202 may receive a fluid for flowing therethrough, which is heated by an external heat source. Heat exchanger 202 includes an inlet pipe 204, an inlet manifold 205, a plurality of heat flow pipes 206, an outlet manifold 207, and an outlet pipe 209. The plurality of heat flow pipes 206 may be a plurality of straight tubes that extend between the inlet and outlet manifolds 205, 207 and allow for flow from the inlet manifold through one of the heat flow pipes 206 and into the outlet manifold 207. The heat flow pipes 206 may be of a consistent geometry and a consistent geometry along the length of each pipe. Each heat flow pipe 206 may be positioned with a space between the adjacent heat flow pipe(s) to allow oil to flow about all or substantially the entire outer surface of each pipe 206 to maximize the surface area for heat transfer from the relatively hot pipe (due to receipt of heat from the hotter fluid that flows through the heating system 200) to transfer heat to the oil.

In some embodiments, the inlet and outlet manifolds 205, 207 extend from a first end 205a (207a) to a second end 205b (207b). The first ends of both the inlet and outlet manifolds are located on the same side of the vat 20. The inlet pipe 204 fluidly connects to the inlet manifold at or proximate to the first end 205a of the first manifold. The outlet pipe 208 fluidly connects to the outlet manifold at or proximate to the second end 207b of the second manifold 207. This connection substantially equalizes the total heat loss (resistance to flow) felt by the oil as it flows through a certain length of the first manifold, then through a certain heat flow pipe 206, and then a remaining certain length of the outlet manifold 207 and then to the outlet pipe 208. This arrangement has been found to increase the overall mass-flow rate of heating fluid through the heating system (for a given pressure urging flow) or reduces the overall pressure needed to cause a desired amount of flow over conventional heating systems. The arrangement, which includes the inlet pipe 204 on one side (right or left) and the outlet pipe 208 on the opposite side (right or left) of the housing 20 assists with equalizing the weight distribution of the overall system when filled with heating oil (because the relatively diameter of the inlet and outlet pipes 204, 208 provide a significant percentage of the total weight of the system when filled with heating oil.

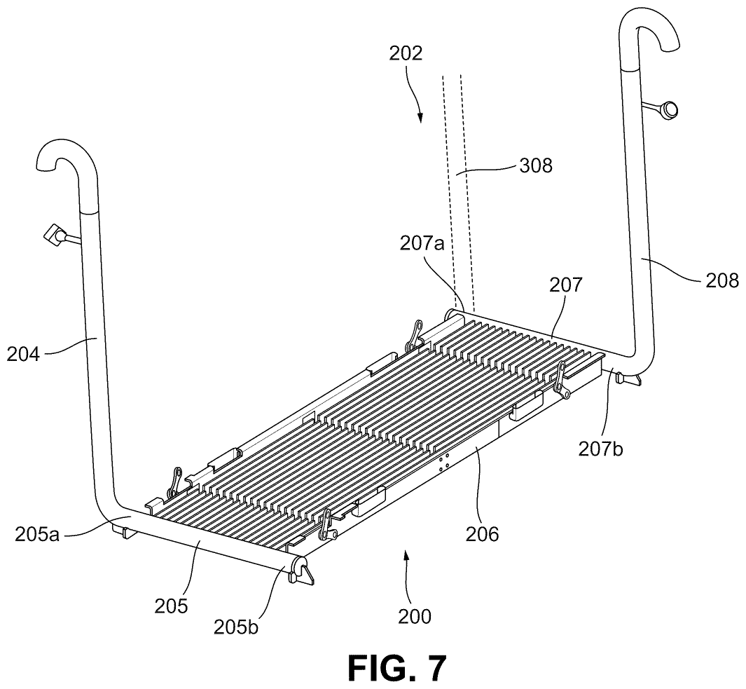

Conventional systems are often formed with an outlet pipe (e.g. 308 depicted with broken lines in FIG. 7) is disposed upon the same side of the heat exchange system as the inlet pipe 204 (i.e. both at or proximate to the first end of the inlet manifolds 205, 207. As can be understood with a review of FIG. 7, in the conventional system, oil that flows through the heat pipes 206 that are proximate to the second ends (205b, 207b) of the inlet and outlet manifolds 205, 207 must flow a longer distance before flowing through the outlet pipe 208 than oil that flows through heat pipes 206 that are proximate to the first ends 205a, 207a of the inlet and outlet manifolds 205, 207. This difference in flow distance between oil that flows through different heat pipes causes different flow rates through each heat pipe (and significant difference between pipes close to the first ends (205a, 207b) and heat pipes close to the second ends (205b, 207b) of the inlet and outlet manifolds. This causes uneven heating of oil depending upon which heat pipe 206 or portion of the inlet or outlet manifolds 205, 207 the oil contacts, which may cause currents within the oil due to uneven heating, different stresses upon the components of the system and other detrimental effect.

The term “about” is specifically defined herein to include a range that includes the reference value and plus or minus 5% of the reference value. The term “substantially the same” is satisfied when the width of the end surfaces of the holes are both within the above range.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:

Numbered Paragraph 1: A system to remove foreign matter from cooking oil, comprising:
a vat that is configured to receive a volume of heated oil for cooking food products therein, the oil when received within the vat establishes a nominal top oil surface during heated cooking operations within the vat, the vat supporting a first conveyor system that causes movement of a food product from an inlet end to an exit end of the vat, the vat is configured to receive the volume of heated oil such that the nominal top oil surface is above at least a portion of the first conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the first conveyor system, and the exit portion is proximate to a different position where the food product exits the vat after reaching an opposite end of the first conveyor system, the vat comprises a bottom surface at a bottom portion thereof, with the sidewall extending vertically from the bottom portion;
a receipt plenum positioned proximate to the exit end of the vat, the receipt plenum includes a housing that includes a front wall, a bottom surface, at least one side surface, further comprising a fluid connection to an external system to filter or otherwise process oil, wherein the fluid connection is disposed within the receipt plenum;
a second conveyor system that extends between the vat and the receipt plenum, the second conveyor system extends from proximate to the inlet end over the exit end of the vat and into a position aligned above the housing of the receipt plenum;
the second conveyor system includes a first portion that moves from a position proximate to the inlet end toward the position aligned above the housing, and a second portion that moves from the position aligned above the housing toward the position proximate to the inlet end, wherein one of the first or second portions of the conveyor moves across and in contact with the bottom portion of the vat.

Numbered Paragraph 2: The system to remove foreign matter from cooking oil of Numbered Paragraph 1, wherein the second portion of the second conveyor system is in contact with and slides along the bottom surface of the vat.

Numbered Paragraph 3: The system to remove foreign matter from cooking oil of either one of Numbered Paragraphs 1 or 2, further comprising a sediment auger that is disposed proximate to the inlet end of the vat, wherein movement of the second portion of the second conveyor system pushes particulate matter that reaches the bottom portion of the vat toward the sediment auger.

Numbered Paragraph 4: The system to remove foreign matter from cooking oil of Numbered Paragraph 3, wherein the second conveyor system moves from the second portion to the first portion with one or more sprockets that are rotatably mounted with respect to the vat.

Numbered Paragraph 5: The system to remove foreign matter from cooking oil of any one of Numbered Paragraphs 1-4, further comprising a transition between the exit end of the vat and the receipt plenum, wherein the transition extends from the exit portion of the vat to the receipt plenum, wherein the transition extends from the exit portion of the vat at an orientation that has a vertically upward vector component and a horizontal vector component that extends away from the exit portion of the side wall and away from the vat, wherein the transition extends to a height that is above a nominal oil level within the vat.

Numbered Paragraph 6: The system to remove foreign matter from cooking oil of Numbered Paragraph 5, wherein the second conveyor system moves across and in contact with a bottom surface of the transition.

Numbered Paragraph 7: The system to remove foreign matter from cooking oil of any one of Numbered Paragraphs 1-6, wherein the second conveyor system includes a third portion that extends substantially vertically downwardly when disposed above the receipt plenum, wherein the third portion extends to a position that is within a storage volume within the receipt plenum and extends to a lowest position that is aligned at a vertical position lower than a top edge of the front wall of the receipt plenum.

Numbered Paragraph 8: The system to remove foreign matter from cooking oil of Numbered Paragraph 7, wherein the third portion has a downwardly extending portion that transitions from the first portion of the second conveyor system and an upwardly extending portion that transitions to the second portion of the first conveyor system.

Numbered Paragraph 9: The system to remove foreign matter from cooking oil of any one of Numbered Paragraphs 1-8, wherein an input to urge movement of the second conveyor system is provided proximate to the inlet end of the vat and wherein the input establishes a transition from the second portion of the second conveyor system to the first portion of the first conveyor system.

Numbered Paragraph 10: The system to remove foreign matter from cooking oil of any one of Numbered Paragraphs 1-9, wherein at least a portion of the bottom surface of the receipt plenum is disposed at an acute angle with respect to a floor surface that the vat rests upon.

Numbered Paragraph 11: The system to remove foreign matter from cooling oil of Numbered Paragraph 10, wherein the entirety of the bottom surface of the receipt plenum is disposed at the acute angle with respect to the floor surface that the vat rests upon.

Numbered Paragraph 12: The system to remove foreign matter from cooking oil of Numbered Paragraph 11, further comprising a valve positioned proximate to the fluid connection, such that when the valve is closed oil from the receipt plenum does not flow through a pipe that extends from the fluid connection, and when the valve is opened oil flows from the pipe.

Numbered Paragraph 13: The system to remove foreign matter from cooking oil of Numbered Paragraph 12, wherein the valve is remotely operable such that the valve opens upon receipt of a signal indicative of a command to open the valve.

Numbered Paragraph 14: The system to remove foreign matter from cooking oil of Numbered Paragraph 13, wherein the valve upon receipt of the signal indicative of the command to open the valve remains open for a fixed period of time.

Numbered Paragraph 15: The system to remove foreign matter from cooking oil of Numbered Paragraph 14, wherein the signal is generated from a timer within a controller such that the signal is generated at a predetermined frequency during operation of the fryer.

Numbered Paragraph 16: The system to remove foreign matter from cooking oil of Numbered Paragraph 13, wherein a timer is initiated when the valve is initially opened and the valve is shut when the timer reaches an elapsed time that is representative of a determined time for the oil within a full receipt plenum to completely drain from the overflow plenum through the aperture.

Numbered Paragraph 17: The system to remove foreign matter from cooking oil of any one of Numbered Paragraphs 1-16, wherein the receipt plenum comprises a first receipt plenum that is fixed to the vat proximate to the entry portion of the vat, and a second receipt plenum that is fixed to the vat proximate to the exit portion of the vat.

Numbered Paragraph 18: The system to remove foreign matter from cooking oil of anyone of Numbered Paragraphs 1-17, wherein the receipt plenum comprises a second fluid connection, wherein the second fluid connection is configured to receive a flow of oil into the receipt plenum, wherein a second valve is provided to allow or prevent flow through the second fluid connection and into the receipt plenum, wherein the first fluid connection is configured to be opened after the second fluid connection has been opened.

Numbered Paragraph 19: An oil receiving system, comprising:
a housing that includes a front wall, a side wall, and a bottom wall, the front wall being configured positioned proximate to an outer edge of a vat and positioned with a space between the outer edge of the vat and the front wall of the housing, the combined front wall, side wall, and bottom wall form a plenum for receipt of oil therein;
further comprising a fluid connection disposed in either the side wall or the bottom wall, the fluid connection vertically disposed below a top edge of the front wall,
further comprising a piped system that allows flow from within the plenum through the fluid connection;
a valve disposed at or proximate to the fluid connection and operable to either allow flow from the plenum through the fluid connection or prevent flow from the plenum through the fluid connection,
further comprising transition between the outer edge of the vat and the front wall of the housing, the transition extends at an upwardly extending orientation from the outer edge of the vat to the front wall of the housing, wherein a conveyor extends along the transition, the conveyor has a first portion that moves along the transition from over the outer edge of the vat and toward and over the front wall of the housing, and a second portion that moves along the transition from over the front wall of the housing and toward and over the outer edge of the vat.

Numbered Paragraph 20: The oil receiving system of Numbered Paragraph 19, wherein the second portion moves across and in contact with a bottom surface of the transition as it moves from over the front wall of the housing and toward and over the outer edge of the vat.

Numbered Paragraph 21: The oil receiving system of Numbered Paragraph 20, wherein the conveyor comprises a third portion between the first and the second portion, wherein the third portion extends over the housing and extends substantially vertically downwardly when disposed above the housing, wherein the third portion extends to a position that is within a storage volume within the receipt plenum and extends to a lowest position that is aligned at a vertical position lower than a top edge of the front wall of the receipt plenum.

Numbered Paragraph 22: The oil receiving system of Numbered Paragraph 21, wherein the third portion has a downwardly extending portion that transitions from the first portion of the second conveyor and an upwardly extending portion that transitions to the second portion of the conveyor.

1. A system to remove foreign matter from cooking oil, comprising:
a vat that is configured to receive a volume of heated oil for cooking food products therein, the oil when received within the vat establishes a nominal top oil surface during heated cooking operations within the vat, the vat supporting a first conveyor system that causes movement of a food product from an inlet end to an exit end of the vat, the vat is configured to receive the volume of heated oil such that the nominal top oil surface is above at least a portion of the first conveyor system, a sidewall of the vat extends vertically above the nominal top surface of the oil, the sidewall includes an entry portion, right and left side portions, and an exit portion, wherein the entry portion is proximate to a position where the food product initially enters into the vat and onto the first conveyor system, and the exit portion is proximate to a different position where the food product exits the vat after reaching an opposite end of the first conveyor system, the vat comprises a bottom surface at a bottom portion thereof, with the sidewall extending vertically from the bottom portion;
a receipt plenum positioned proximate to the exit end of the vat, the receipt plenum includes a housing that includes a front wall, a bottom surface, at least one side surface, further comprising a fluid connection to an external system to filter or otherwise process oil, wherein the fluid connection is disposed within the receipt plenum;
a second conveyor system that extends between the vat and the receipt plenum, the second conveyor system extends from proximate to the inlet end over the exit end of the vat and into a position aligned above the housing of the receipt plenum;
the second conveyor system includes a first portion that moves from a position proximate to the inlet end toward the position aligned above the housing, and a second portion that moves from the position aligned above the housing toward the position proximate to the inlet end, wherein one of the first or second portions of the conveyor moves across and in contact with the bottom portion of the vat.

2. The system to remove foreign matter from cooking oil of claim 1, wherein the second portion of the second conveyor system is in contact with and slides along the bottom surface of the vat.

3. The system to remove foreign matter from cooking oil of claim 2, further comprising a sediment auger that is disposed proximate to the inlet end of the vat, wherein movement of the second portion of the second conveyor system pushes particulate matter that reaches the bottom portion of the vat toward the sediment auger.

4. The system to remove foreign matter from cooking oil of claim 3, wherein the second conveyor system moves from the second portion to the first portion with one or more sprockets that are rotatably mounted with respect to the vat.

5. The system to remove foreign matter from cooking oil of claim 1, further comprising a transition between the exit end of the vat and the receipt plenum, wherein the transition extends from the exit portion of the vat to the receipt plenum, wherein the transition extends from the exit portion of the vat at an orientation that has a vertically upward vector component and a horizontal vector component that extends away from the exit portion of the side wall and away from the vat, wherein the transition extends to a height that is above a nominal oil level within the vat.

6. The system to remove foreign matter from cooking oil of claim 5, wherein the second conveyor system moves across and in contact with a bottom surface of the transition.

7. The system to remove foreign matter from cooking oil of claim 1, wherein the second conveyor system includes a third portion that extends substantially vertically downwardly when disposed above the receipt plenum, wherein the third portion extends to a position that is within a storage volume within the receipt plenum and extends to a lowest position that is aligned at a vertical position lower than a top edge of the front wall of the receipt plenum.

8. The system to remove foreign matter from cooking oil of claim 7, wherein the third portion has a downwardly extending portion that extends from the first portion of the second conveyor system and an upwardly extending portion that extends to the second portion of the first conveyor system.

9. The system to remove foreign matter from cooking oil of claim 6, wherein an input to urge movement of the second conveyor system is provided proximate to the inlet end of the vat and wherein the input establishes a transition from the second portion of the second conveyor system to the first portion of the first conveyor system.

10. The system to remove foreign matter from cooking oil of claim 1, wherein at least a portion of the bottom surface of the receipt plenum is disposed at an acute angle with respect to a floor surface that the vat rests upon.

11. The system to remove foreign matter from cooling oil of claim 10, wherein the entirety of the bottom surface of the receipt plenum is disposed at the acute angle with respect to the floor surface that the vat rests upon.

12. The system to remove foreign matter from cooking oil of claim 11, further comprising a valve positioned proximate to the fluid connection, such that when the valve is closed oil from the receipt plenum does not flow through a pipe that extends from the fluid connection, and when the valve is opened oil flows from the pipe.

13. The system to remove foreign matter from cooking oil of claim 12, wherein the valve is remotely operable such that the valve opens upon receipt of a signal indicative of a command to open the valve.

14. The system to remove foreign matter from cooking oil of claim 13, wherein the valve upon receipt of the signal indicative of the command to open the valve remains open for a fixed period of time.

15. The system to remove foreign matter from cooking oil of claim 14, wherein the signal is generated from a timer within a controller such that the signal is generated at a predetermined frequency during operation of the fryer.

16. The system to remove foreign matter from cooking oil of claim 13, wherein a timer is initiated when the valve is initially opened and the valve is shut when the timer reaches an elapsed time that is representative of a determined time for the oil within a full receipt plenum to completely drain from the overflow plenum through the aperture.

17. The system to remove foreign matter from cooking oil of claim 1, wherein the receipt plenum comprises a first receipt plenum that is fixed to the vat proximate to the entry portion of the vat, and a second receipt plenum that is fixed to the vat proximate to the exit portion of the vat.

18. The system to remove foreign matter from cooking oil of claim 1, wherein the receipt plenum comprises a second fluid connection, wherein the second fluid connection is configured to receive a flow of oil into the receipt plenum, wherein a second valve is provided to allow or prevent flow through the second fluid connection and into the receipt plenum, wherein the first fluid connection is configured to be opened after the second fluid connection has been opened.

19. An oil receiving system, comprising:
a housing that includes a front wall, a side wall, and a bottom wall, the front wall being configured positioned proximate to an outer edge of a vat and positioned with a space between the outer edge of the vat and the front wall of the housing, the combined front wall, side wall, and bottom wall form a plenum for receipt of oil therein;
further comprising a fluid connection disposed in either the side wall or the bottom wall, the fluid connection vertically disposed below a top edge of the front wall,
further comprising a piped system that allows flow from within the plenum through the fluid connection;
a valve disposed at or proximate to the fluid connection and operable to either allow flow from the plenum through the fluid connection or prevent flow from the plenum through the fluid connection,
further comprising transition between the outer edge of the vat and the front wall of the housing, the transition extends at an upwardly extending orientation from the outer edge of the vat to the front wall of the housing, wherein a conveyor extends along the transition, the conveyor has a first portion that moves along the transition from over the outer edge of the vat and toward and over the front wall of the housing, and a second portion that moves along the transition from over the front wall of the housing and toward and over the outer edge of the vat.

20. The oil receiving system of claim 19, wherein the second portion moves across and in contact with a bottom surface of the transition as it moves from over the front wall of the housing and toward and over the outer edge of the vat.

21. The oil receiving system of claim 20, wherein the conveyor comprises a third portion between the first and the second portion, wherein the third portion extends over the housing and extends substantially vertically downwardly when disposed above the housing, wherein the third portion extends to a position that is within a storage volume within the receipt plenum and extends to a lowest position that is aligned at a vertical position lower than a top edge of the front wall of the receipt plenum.

22. The oil receiving system of claim 21, wherein the third portion has a downwardly extending portion that transitions from the first portion of the second conveyor and an upwardly extending portion that transitions to the second portion of the conveyor.
